(19) United States
(12) Patent Application Publication
(10) Pub. No.: US 2016/0352165 A1
(43) Pub. Date: Dec. 1, 2016

(54) LAMINATED CORE FOR ROTARY ELECTRIC MACHINE

(71) Applicant: TOYOTA JIDOSHA KABUSHIKI KAISHA, Toyota-shi (JP)

(72) Inventor: Shingo FUBUKI, Nisshin-shi (JP)

(73) Assignee: TOYOTA JIDOSHA KABUSHIKI KAISHA, Toyota-shi (JP)

(21) Appl. No.: 15/160,260

(22) Filed: May 20, 2016

(30) Foreign Application Priority Data
May 29, 2015 (JP) 2015-110681

(51) Int. Cl. H02K 1/28; H02K 1/27

(52) U.S. Cl. CPC H02K 1/28; H02K 1/2766

(57) ABSTRACT

A laminated core for a rotary electric machine includes a disc-shaped first laminated block, a disc-shaped second laminated block and an end steel sheet. The first and second laminated block are formed by a plurality of main steel sheets that have a protruding dowel crimping portion and that are laminated together. The second laminated block being front/back reversed with respect to the first laminated block around a reference line of the first laminated block. The end steel sheet has a first dowel insertion hole formed in a position corresponding to the dowel crimping portion of the first laminated block, and a second dowel insertion hole formed in a position symmetrical to the first dowel insertion hole with respect to the reference line of the first laminated block. The end steel sheet is arranged in a position between opposing surfaces of the first laminated block and the second laminated block.

### INCORPORATION BY REFERENCE

The disclosure of Japanese Patent Application No. 2015-110681 filed on May 29, 2015 including the specification, drawings and abstract is incorporated herein by reference in its entirety.

### BACKGROUND OF THE INVENTION

1. Field of the Invention

The invention relates to a laminated core formed by steel sheets that are laminated together, which is used in a rotor of a rotary electric machine such as a motor or a generator.

2. Description of Related Art

Japanese Patent Application Publication No. 2010-141989 (JP 2010-141989 A) is related art. A plurality of magnet insertion holes are formed by punching at equally-spaced intervals in the circumferential direction in steel sheets described in JP 2010-141989 A. These steel sheets are laminated together in an extending direction of a rotational axis to form a laminated core. Magnets are then loaded into the magnet insertion holes of this laminated core, such that a rotor is formed.

This laminated core may be formed by stacking together a plurality of blocks, each of which is formed by a plurality of steel sheets laminated together by dowel crimping (hereinafter, these blocks will be referred to as “laminated blocks”). In this case, when surface aligning a surface of one laminated block with a surface of another laminated block having the same shape as the first laminated block, a dowel protruding from the surface of the one laminated block may end up hitting the dowel protruding from the surface of the other laminated block. Also, even if the dowels do not hit each other, there will be a gap between the laminated blocks due to the dowels. If there is a gap due to the dowels, the thickness of the laminated core in the rotational axis direction will tend to be uneven in the circumferential direction, which may diminish the rotational balance of the laminated core.

### SUMMARY OF THE INVENTION

The invention thus provides a laminated core for a rotary electric machine with improved rotational balance.

A first aspect of the invention relates to a laminated core for a rotary electric machine, which includes a disc-shaped first laminated block, a disc-shaped second laminated block, and an end steel sheet. The disc-shaped first laminated block is formed by a plurality of main steel sheets that are laminated together, each of the main steel sheets having a protruding dowel crimping portion that is arranged in a position off from a reference line that extends along a diameter of the first laminated block. The disc-shaped second laminated block is formed by a plurality of main steel sheets that are laminated together, each of the main steel sheets having a protruding dowel crimping portion that is arranged in a position off from a reference line that extends along a diameter of the second laminated block. The second laminated block is front/back reversed with respect to the first laminated block around the reference line of the first laminated block. The end steel sheet has a first dowel insertion hole formed in a position corresponding to the dowel crimping portion of the first laminated block, and a second dowel insertion hole formed in a position symmetrical to the first dowel insertion hole with respect to the reference line of the first laminated block. The first laminated block and the second laminated block are arranged such that the dowel crimping portion of the first laminated block protrudes in a direction toward the second laminated block, and the dowel crimping portion of the second laminated block protrudes in a direction toward the first laminated block, and the reference line of the first laminated block and the reference line of the second laminated block match up. The end steel sheet is arranged in a position between opposing surfaces of the first laminated block and the second laminated block.

In this first aspect, in the laminated core for a rotary electric machine, when the first laminated block and the second laminated block in a state front/back reversed from the first laminated block are surface aligned such that reference lines match up, the dowel protruding from the first dowel insertion hole in the first laminated block is inserted into the second dowel insertion hole in the second laminated block. Also, the dowel protruding from the first dowel insertion hole in the second laminated block is inserted into the second dowel insertion hole in the first laminated block. In this way, the surface of the first laminated block and the surface of the second laminated block are able to be brought into close contact, such that there is no gap due to the dowels between the laminated blocks. As a result, even if the laminated core in which the first laminated block and the second laminated block that is in a front/back reversed state are surface aligned is used, the rotational balance of the laminated core will not be diminished. Also, if there is a gap between the first laminated block and the second laminated block, electrical loss will tend to occur, which will cause a reduction in torque. However, according to the aspect described above, such a situation is extremely unlikely to occur.

In the first aspect described above, the end steel sheet may be provided in plurality, with at least one being provided abutting against a flat end surface of the laminated main steel sheets of the first laminated block, and at least one being provided abutting against a flat end surface of the laminated main steel sheets of the second laminated block. According to this aspect, at least one end steel sheet is arranged as a portion of each of the laminated blocks, so the end steel sheets will not easily separate when arranging the first laminated block and the second laminated block face to face. Also, in the first aspect described above, the end steel sheet being sandwiched between the first laminated block and the second laminated block.

Also, in the aspect described above, the dowel crimping portion, the first dowel insertion hole, and the second dowel insertion hole may be formed between a rotational axis that passes through the center of the first laminated block and the second laminated block, and a plurality of magnet insertion holes arranged in a circumferential direction of the first laminated block and the second laminated block, in the first laminated block and the second laminated block. With this kind of structure, when the magnet insertion holes are compactly arranged in the circumferential direction, deformation is less apt to occur in the steel sheets between the magnet insertion holes and the rotational axis of the laminated block than between the magnet insertion holes and the outer periphery of the laminated block when dowel crimping. Therefore, the steel sheets are able to be reliably dowel crimped together.

According to this aspect, rotational balance of the laminated core is able to be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a plan view of a first example embodiment of the laminated core for a rotary electric machine according to the invention;

FIG. 2 is a side view of a state in which a surface of a first laminated block and a surface of a second laminated block are facing each other;

FIG. 3A is a plan view of a main steel sheet used in the first laminated block;

FIG. 3B is a plan view of an end steel sheet used in the first laminated block;

FIG. 4A is a plan view of a main steel sheet used in the second laminated block;

FIG. 4B is a plan view of an end steel sheet used in the second laminated block;

FIG. 5A is a sectional view of the major portions of the first and second laminated blocks;

FIG. 5B is another sectional view of the major portions of the first and second laminated blocks;

FIG. 6 is a side view of a state in which the first laminated block and the second laminated block are surface aligned;

FIG. 7 is a side view of a second example embodiment of the laminated core for a rotary electric machine according to the invention;

FIG. 8 is a plan view of a first laminated block used in the laminated core in FIG. 7;

FIG. 9 is a plan view of a second laminated block used in the laminated core in FIG. 7; and

FIG. 10 is a plan view of an end steel sheet used in the laminated core in FIG. 7.

### DETAILED DESCRIPTION OF EMBODIMENTS

Hereinafter, example embodiments of a laminated core for a rotary electric machine according to the invention will be described in detail with reference to the accompanying drawings.

### First Example Embodiment

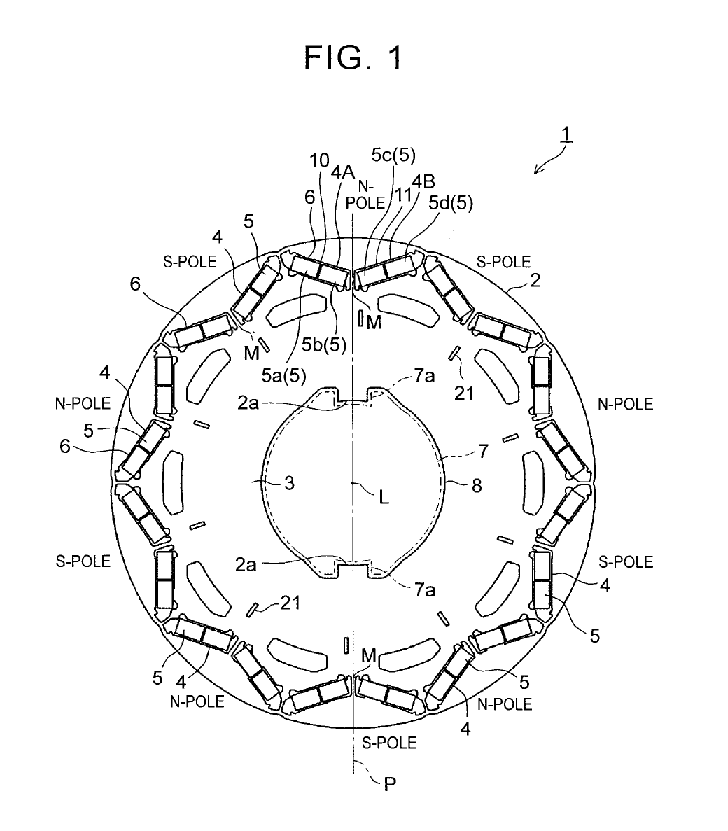

A rotor 1 shown in FIG. 1 is used in a rotary electric machine such as a motor or generator of a hybrid vehicle. Aside from a hybrid vehicle, the rotor 1 may also be used in an electric vehicle or a fuel cell vehicle.

The rotor 1 includes a laminated core 3 in which thin steel sheets 2 that are formed by insulation-coated steel sheets that have been punched out in a disc shape, are laminated together in an extending direction of a rotational axis L, and magnets 5 arranged in magnet insertion holes 4 formed punched out of the disc-shaped steel sheets 2. A shaft insertion hole 8 for inserting a shaft 7 is formed in the center of each steel sheet 2. A key portion 2a that is used as a shaft connecting portion is formed on a peripheral edge of the shaft insertion hole 8, and a key groove 7a into which the key portion 2a is inserted is provided in the shaft 7. The key portion 2a is formed protruding toward the rotational axis L. Two of these key portions 2a are arranged at 180° phases in a circumferential direction. A key groove may also be employed as a shaft connecting portion formed in the steel sheet 2.

Also, S-poles and N-poles are arranged alternately in the circumferential direction on the rotor 1, with four magnets 5a to 5d arranged distributed among two magnet insertion holes 4 at each pole. The magnet insertion holes 4 provided for each pole are inclined from the outside toward the inside in the radial direction, and arranged in a V-shape such that an apex M is positioned on the inside. Also, at each pole, first and second magnets 5a and 5b are arranged in one magnet insertion hole 4A, and third and fourth magnets 5c and 5d are arranged in the other magnet insertion hole 4B.

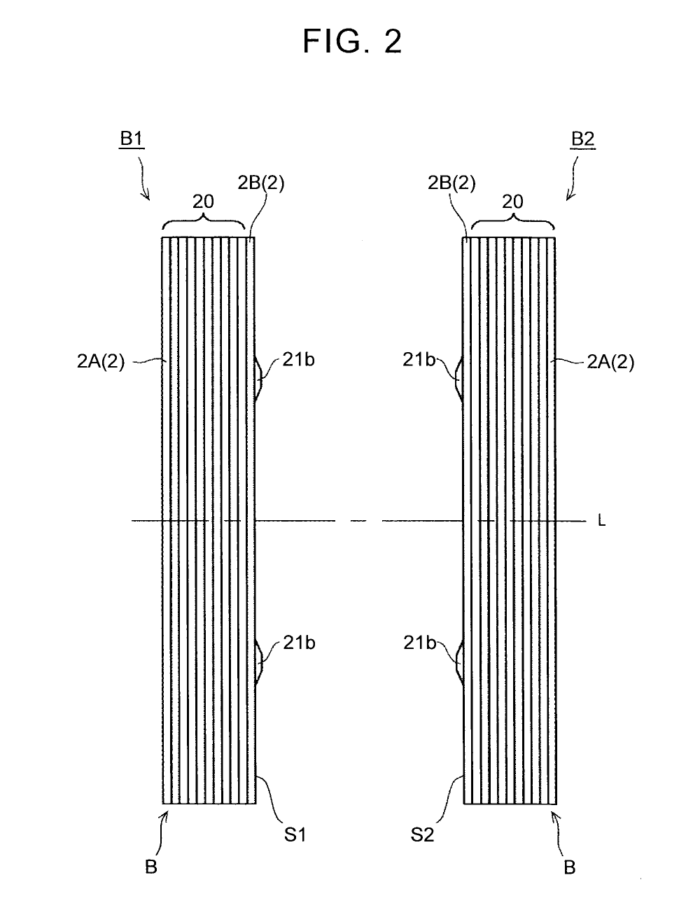

The laminated core 3 is formed by a plurality of (e.g., 10 to 20) laminated blocks B (see FIG. 2) that are laminated together, each laminated block B being formed by a plurality of (e.g., 10 to 20) the steel sheets 2 having the magnet insertion holes 4 formed in the circumferential direction that are laminated together. With each laminated block B, protruding portions 6 that protrude toward the inside of the magnet insertion holes 4 are made to emerge in different positions in the rotational axis L direction, by rotating the laminated blocks B a predetermined angle around a center point (the point through which the rotational axis L passes) of the steel sheets 2 that have the same shape, and reversing the fronts and backs of the steel sheets 2, when laminating the steel sheets 2 together. The magnets 5 are supported in the magnet insertion holes 4 by these protruding portions 6.

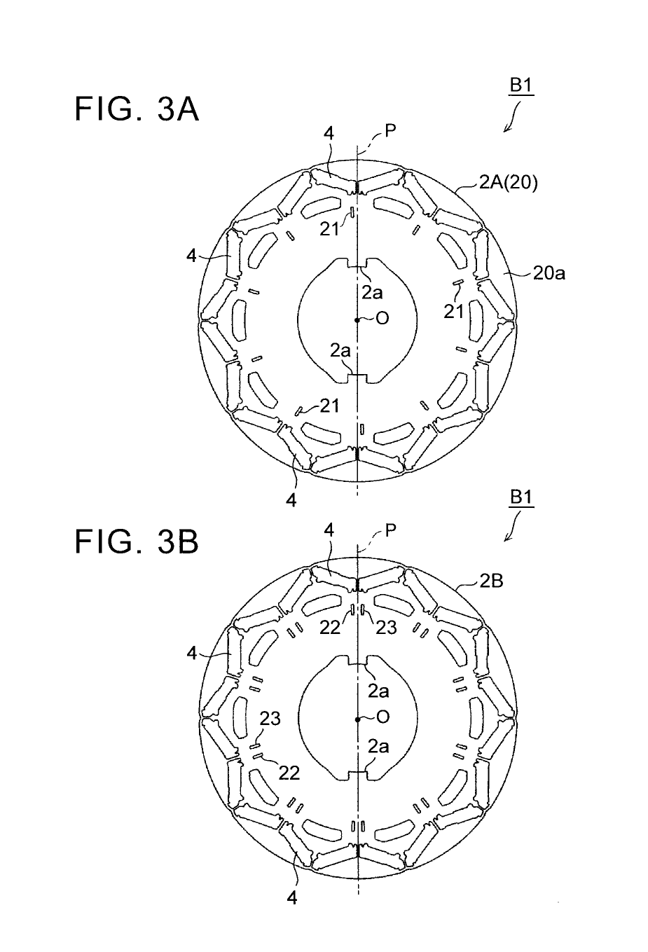

Hereinafter, a case will be described in which the surfaces of the same type of blocks B are surface aligned such that reference lines P (see FIGS. 3A and 3B) are aligned, when forming the laminated core 3. The reference lines P extend along the diameters of the disc-shaped laminated blocks B.

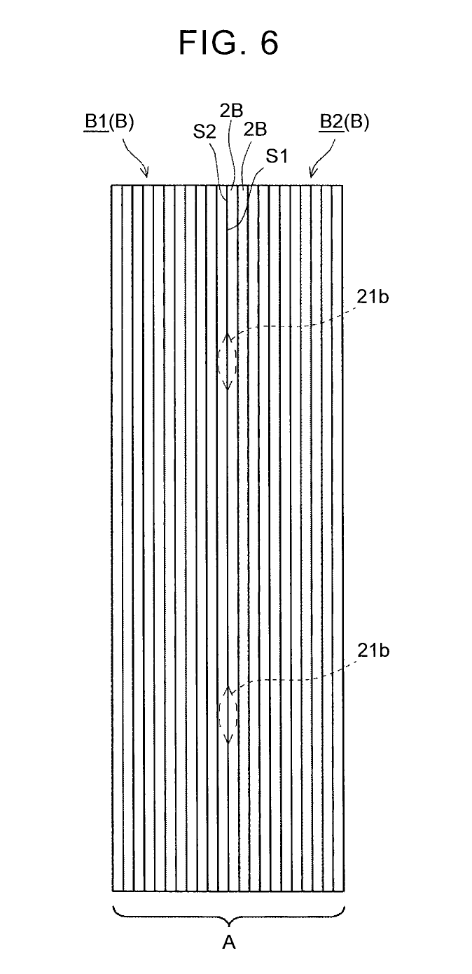

As shown in FIG. 2, when forming the laminated core 3, a surface S1 of a first laminated block B1 formed by the laminated steel sheets 2 is made to face a surface S2 of a second laminated block B2 that has been front/back reversed around the reference line P (see FIG. 3) that extends along the diameter thereof, with respect to the first laminated block B1, such that the reference line P of the first laminated block B1 is aligned with the reference line P of the second laminated block B2. Then, the surface S1 of the first laminated block B1 is surface aligned with the surface S2 of the second laminated block B2, as shown in FIG. 6. With the laminated core 3, when the first laminated block B1 and the second laminated block B2 are combined to form a single unit A, a plurality of these units A are overlapped. In the unit A, the magnet insertion holes 4 of the first laminated block B1 and the magnet insertion holes 4 of the second laminated block B2 are arranged in the same position in the rotational axis L direction.

The first laminated block B1 will now be described.

The first laminated block B1 includes a block main body portion 20 (see FIG. 2) formed by a plurality of main steel sheets 2A (see FIG. 3A) with dowel crimping portions 21, that have been laminated together, and an end steel sheet 2B (see FIG. 3B) that abuts against a flat end surface 20a of the block main body portion 20. The main steel sheets 2A are laminated one by one.

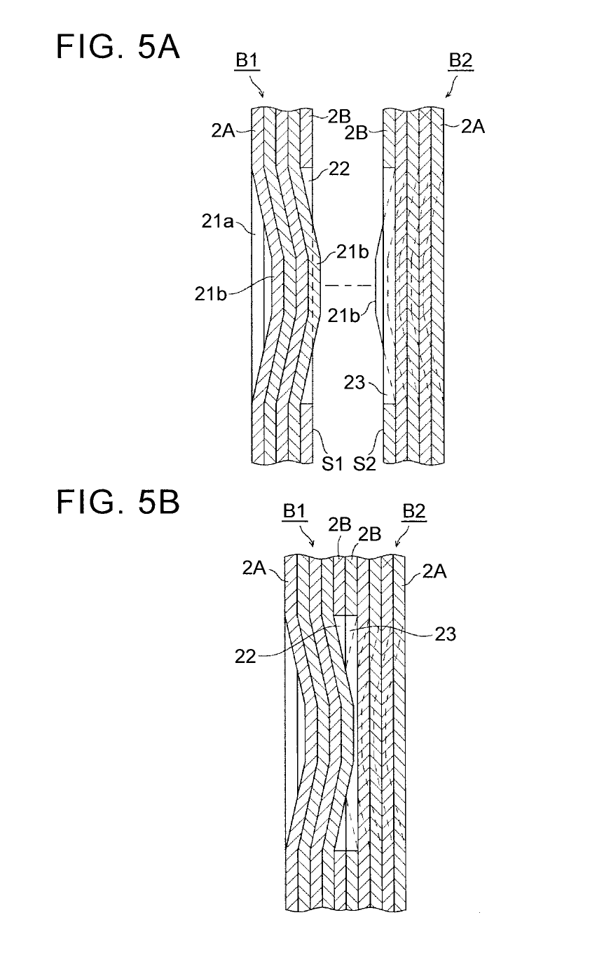

As shown in FIGS. 3A and 5, the dowel crimping portions 21 are formed in positions off in the circumferential direction from the reference line P that passes through the center O, on the main steel sheets 2A that form the block main body portion 20. The dowel crimping portions 21 are formed at equally-spaced intervals in the circumferential direction. Each dowel crimping portion 21 includes a notch 21a formed parallel to the radial direction of the main steel sheets 2A by punching with a press, and a trapezoidal-shaped dowel 21b that has been pushed out by punching. Also, with the block main body portion 20, the main steel sheets 2A are integrated by the dowels overlapping with each other.

The dowel crimping portions 21 each have a long narrow rectangular shape in the radial direction, and are formed between the magnet insertion holes 4 and the rotational axis L that passes through the center. The magnet insertion holes 4 are compactly arranged in the circumferential direction, so deformation is less apt to occur in the main steel sheets 2A between the magnet insertion holes 4 and the rotational axis L of the block main body portion 20 than between the magnet insertion holes 4 and the outer periphery of the block main body portion 20 when dowel crimping. Therefore, the main steel sheets 2A are able to be reliably dowel crimped together.

As shown in FIGS. 3B and 5, the end steel sheet 2B has first dowel insertion holes 22 formed in positions corresponding to the dowel crimping portions 21, and second dowel insertion holes 23 formed in positions symmetrical to the first dowel insertion holes 22 with respect to the reference line P. The first and second dowel insertion holes 22 and 23 are arranged at equally-spaced intervals in the circumferential direction.

When forming the first laminated block B1, dowels 21b that protrude from the flat end surface 20a of the block main body portion 20 are inserted into the first dowel insertion holes 22 of the end steel sheet 2B. Also, the top portions of the dowels 21b protrude from the surface S1 of the first laminated block B1. The protrusion amount of the dowels 21b is made large to increase the dowel crimping strength. As a result, the dowels 21b pass through the first dowel insertion holes 22 and protrude from the surface S1 of the first laminated block B1.

The reference line P described above extends through the pair of two key portions 2a used as shaft connecting portions. Moreover, as shown in FIG. 1, this reference line P also passes through an apex M between a first magnet insertion portion 10 and a second magnet insertion portion 11. When creating the second laminated block B2 in a state in which the first laminated block B1 has been front/back reversed, the key portions (shaft connecting portions) 2a are able to be used as reversal references, so the second laminated block B2 is able to be reliably reversed (i.e., turned over) with a turnover device.

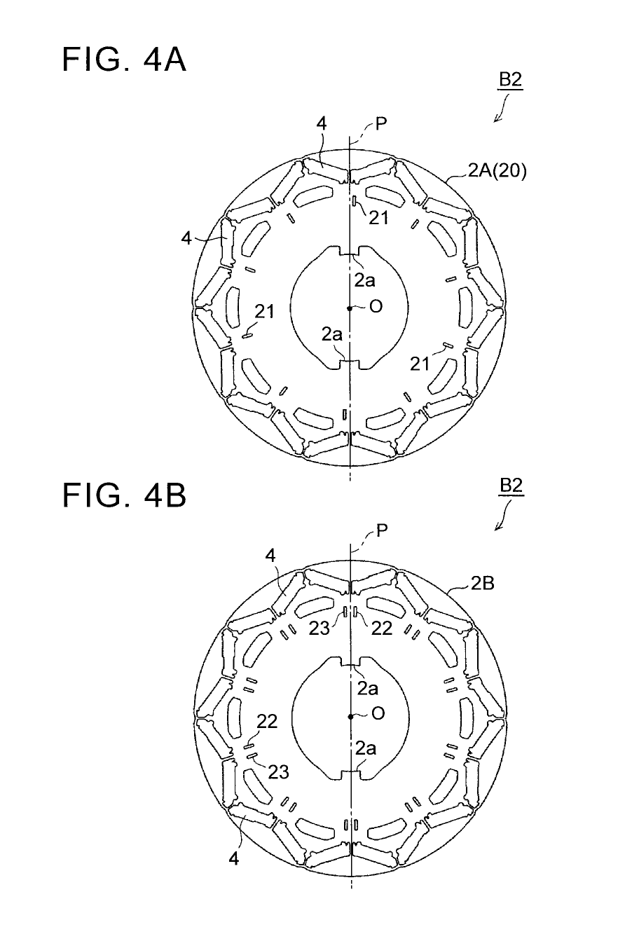

FIG. 4A is a view of the main steel sheets 2A used in the second laminated block B2 that is in a state in which the first laminated block B1 has been front/back reversed around the reference line P. In this case, the dowel crimping portions 21 of the second laminated block B2 are arranged in positions symmetrical to the dowel crimping portions 21 of the first laminated block B1 with respect to the reference line P. That is, as a result of the front/back reversal, the dowel crimping portion 21 of the first laminated block B1 in the FIG. 3A that is positioned on the left side of the reference line P in the drawing corresponds to the dowel crimping portion 21 of the second laminated block B2 positioned on the right side of the reference line P in the FIG. 4A.

FIG. 4B is a view of the end steel sheet 2B of the second laminated block B2. With the second laminated block B2 as well, the dowel crimping portions 21 are inserted into the first dowel insertion holes 22.

As shown in FIG. 2, when forming the unit A (see FIG. 6), the surface S1 of the first laminated block B1 is made to face the surface S2 of the second laminated block B2. At this time, the dowels 21b protrude from the surface S1 of the first laminated block B1, and the dowels 21b also protrude from the surface S2 of the second laminated block B2. Then, the end steel sheets 2B will not easily separate even when the first laminated block B1 and the second laminated block B2 are brought face to face.

As shown in FIG. 6, when the surface S1 of the first laminated block B1 is abutted against the surface S2 of the second laminated block B2, the dowels 21b that protrude from the surface S1 of the first laminated block B1 are inserted into the second dowel insertion holes 23 of the second laminated block B2 (see FIG. 5). Also, the dowels 21b that protrude from the surface S2 of the second laminated block B2 are also similarly inserted into the second dowel insertion holes 23 of the first laminated block B1.

In this way, the surface S1 of the first laminated block B1 and the surface S2 of the second laminated block B2 are able to be brought into close contact with one another, such that there is no gap due to the dowels 21b between the first laminated block B1 and the second laminated block B2. As a result, even if the laminated core 3 in which the first laminated block B1 and the second laminated block B2 that is in a front/back reversed state are surface aligned is used, the rotational balance of the laminated core 3 will not be diminished. Also, if there is a gap between the first laminated block B1 and the second laminated block B2, electrical loss will tend to occur, which will cause a reduction in torque. However, with the laminated core 3 according to this example embodiment, such a situation is extremely unlikely to occur.

### Second Example Embodiment

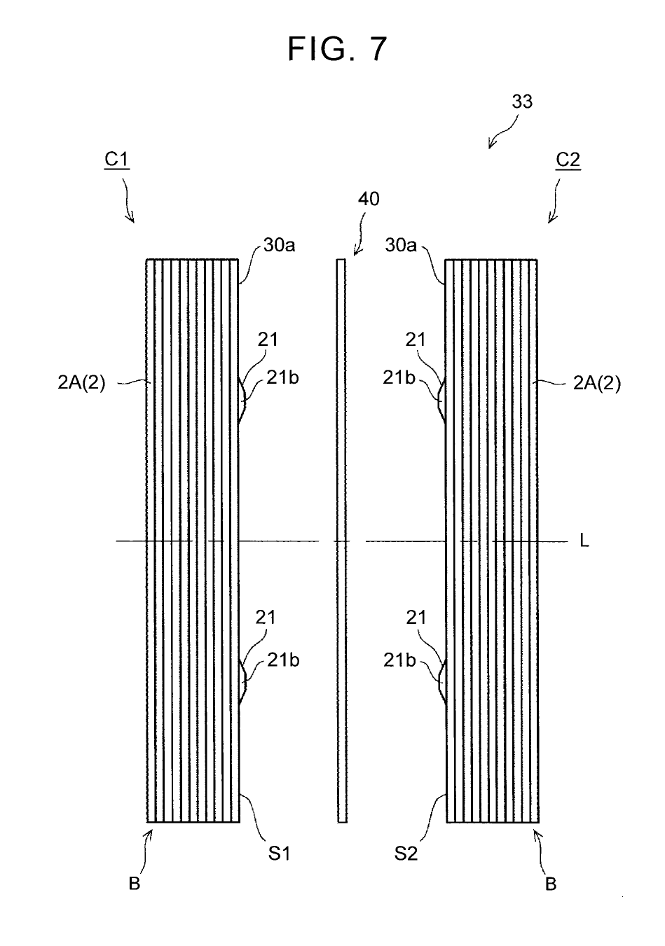

A disc-shaped first laminated block C1 and a disc-shaped second laminated block C2 are both made from main steel sheets 2A having dowel crimping portions, as shown in FIGS. 7 to 10. An end steel sheet 40 is sandwiched between a flat end surface 30a of the first laminated block C1 and a flat end surface 30a of the second laminated block C2. The second laminated block C2 with dowels 21b protruding from the flat end surface 30a is the same as the first laminated block C1 that has been front/back reversed around a reference line P that extends along the diameter thereof. That is, the first laminated block C1 and the second laminated block C2 that have the same shape are used.

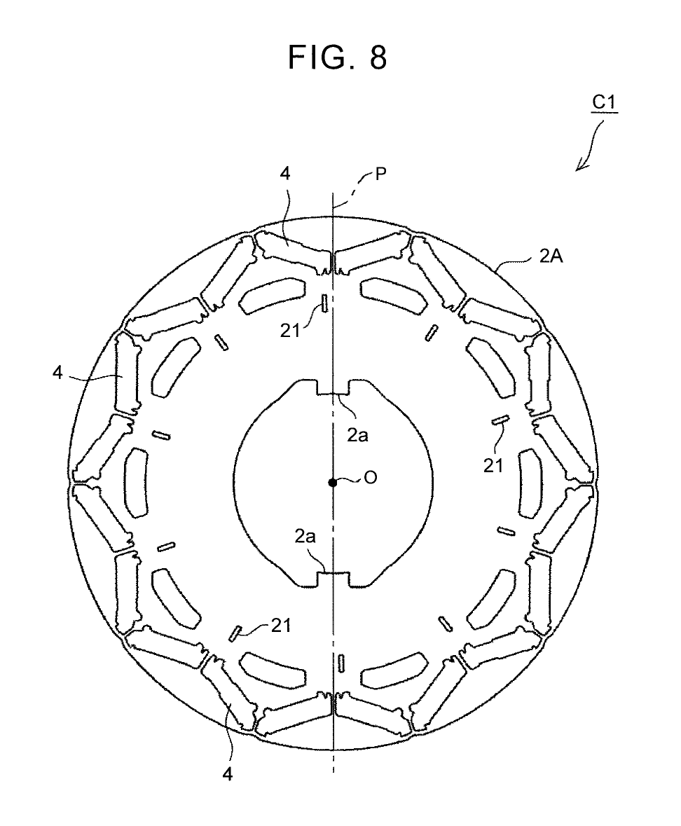

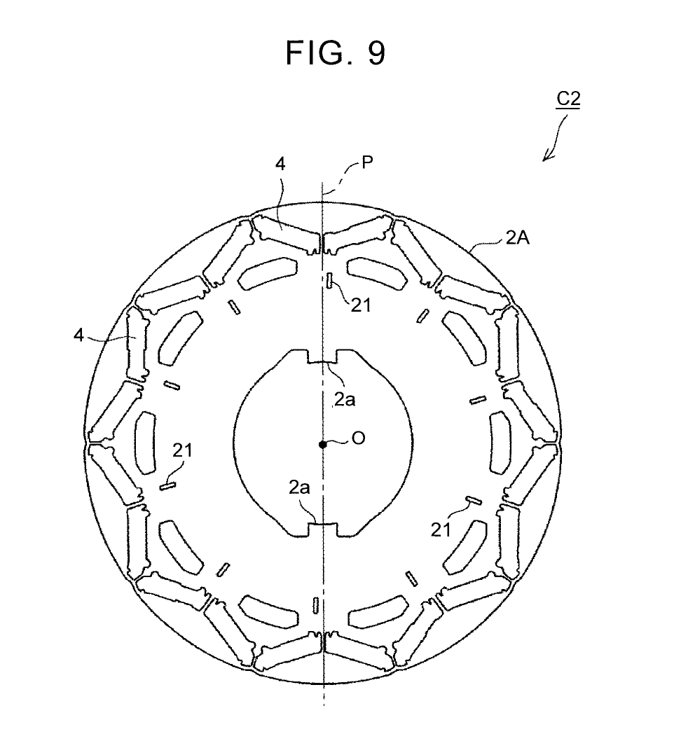

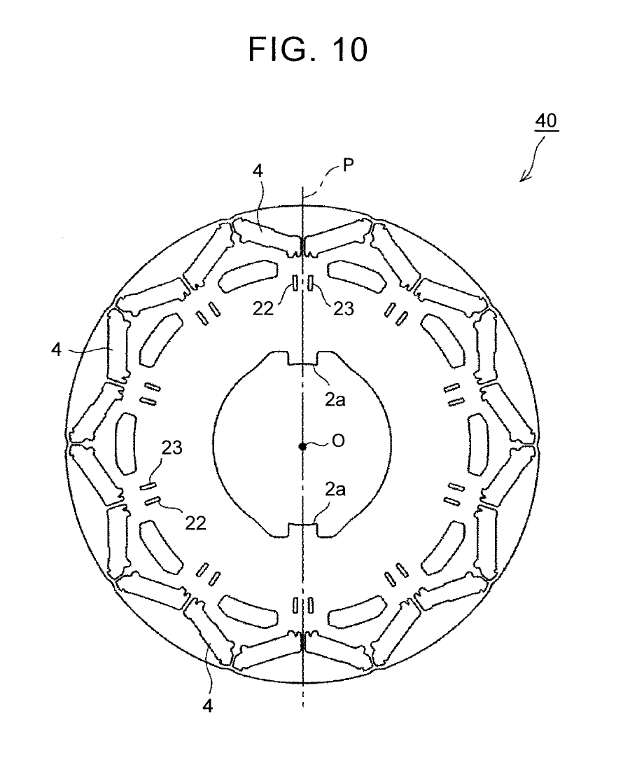

As shown in FIGS. 8 and 9, the dowel crimping portions 21 are arranged in positions off in the circumferential direction from the reference line P. As shown in FIG. 10, the end steel sheet 40 has first dowel insertion holes 22 formed in positions corresponding to the dowel crimping portions 21 of the first laminated block C1, and second dowel insertion holes 23 that are formed in positions symmetrical to the first dowel insertion holes 22 with respect to the reference line P, and formed in positions corresponding to the dowel crimping portions 21 of the second laminated block C2.

When forming a laminated core 33, the dowels 21b that protrude from the flat end surface 30a of the first laminated block C1 are inserted into the first dowel insertion holes 22 of the end steel sheet 40. The dowels 21b that protrude from the flat end surface 30a of the second laminated block C2 are inserted into the second dowel insertion holes 23 of the end steel sheet 40.

The invention is not limited to the example embodiments described above. Various modifications such as those described below are also possible.

For example, the shape of the dowel crimping portions 21 may also be rectangular, square, or circular. The position of the dowel crimping portions 21 may also be between the outer periphery of the laminated block B1, B2, C1, and C2 and the magnet insertion holes 4.

The key portions 2a do not have to be provided on the laminated block B1, B2, C1, and C2 and the end steel sheet 40.

What is claimed is:

1. A laminated core for a rotary electric machine, comprising:
a disc-shaped first laminated block formed by a plurality of main steel sheets that are laminated together, each of the main steel sheets having a protruding dowel crimping portion that is arranged in a position off from a reference line that extends along a diameter of the first laminated block;
a disc-shaped second laminated block formed by a plurality of main steel sheets that are laminated together, each of the main steel sheets having a protruding dowel crimping portion that is arranged in a position off from a reference line that extends along a diameter of the second laminated block, the second laminated block being front/back reversed with respect to the first laminated block around the reference line of the first laminated block; and
an end steel sheet that has a first dowel insertion hole formed in a position corresponding to the dowel crimping portion of the first laminated block, and a second dowel insertion hole formed in a position symmetrical to the first dowel insertion hole with respect to the reference line of the first laminated block,
wherein the first laminated block and the second laminated block are arranged such that the dowel crimping portion of the first laminated block protrudes in a direction toward the second laminated block, and the dowel crimping portion of the second laminated block protrudes in a direction toward the first laminated block, and the reference line of the first laminated block and the reference line of the second laminated block match up; and
the end steel sheet is arranged in a position between opposing surfaces of the first laminated block and the second laminated block.

2. The laminated core according to claim 1, wherein the end steel sheet is provided in plurality, with at least one being provided abutting against a flat end surface of the laminated main steel sheets of the first laminated block, and at least one being provided abutting against a flat end surface of the laminated main steel sheets of the second laminated block.

3. The laminated core according to claim 1, wherein the end steel sheet being sandwiched between the first laminated block and the second laminated block.

4. The laminated core according to claim 1, wherein
the dowel crimping portion, the first dowel insertion hole, and the second dowel insertion hole are formed between a rotational axis that passes through the center of the first laminated block and the second laminated block, and a plurality of magnet insertion holes arranged in a circumferential direction of the first laminated block and the second laminated block, in the first laminated block and the second laminated block.
